(19) United States
(12) Patent Application Publication
(10) Pub. No.: US 2007/0230638 A1
(43) Pub. Date: Oct. 4, 2007

(54) Method and apparatus to efficiently configure multi-antenna equalizers

(76) Inventor: Meir Griniasty, Kfar Azar (IL)

Correspondence Address: THE LAW OFFICES OF JOHN C. SCOTT, LLC;C/O INTELLEVELE, P. O. BOX 52050, MINNEAPOLIS, MN, 55402, US

(21) Appl. No.: 11/394,533

(22) Filed: Mar. 30, 2006

(51) Int. Cl. H04L 1/02

(52) U.S. Cl. 375/347

(57) ABSTRACT

Techniques and structures are provided for use in configuring an MMSE equalizer in a multiple antenna system in a computationally efficient manner.

### TECHNICAL FIELD

The invention relates generally to wireless communication and, more particularly, to techniques for processing signals received from a wireless channel.

### BACKGROUND OF THE INVENTION

Equalizers may be used in wireless receivers to reduce the effects of channel distortion (e.g., inter symbol interference (ISI), etc.) within received signals. In a multiple antenna receiver, a separate equalizer may be used for each of the antennas, but optimally all of the equalizers should be calculated together. As the characteristics of the wireless channel change with time in a wireless system, the configuration of the equalizers (e.g., the filter tap weights, etc.) within the wireless receiver needs to be adjusted. Techniques are needed for generating these equalizer updates in a computationally efficient manner.

### BRIEF DESCRIPTION OF THE DRAWINGS

FIG. 1 is a diagram illustrating a wireless communication arrangement that may implement features of the present invention;

FIG. 2 is a block diagram illustrating a portion of an example wireless receiver in accordance with an embodiment of the present invention; and

FIG. 3 is a diagram illustrating an example processing sequence that may be followed to generate MMSE filter configuration information in a multiple antenna wireless receiver in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

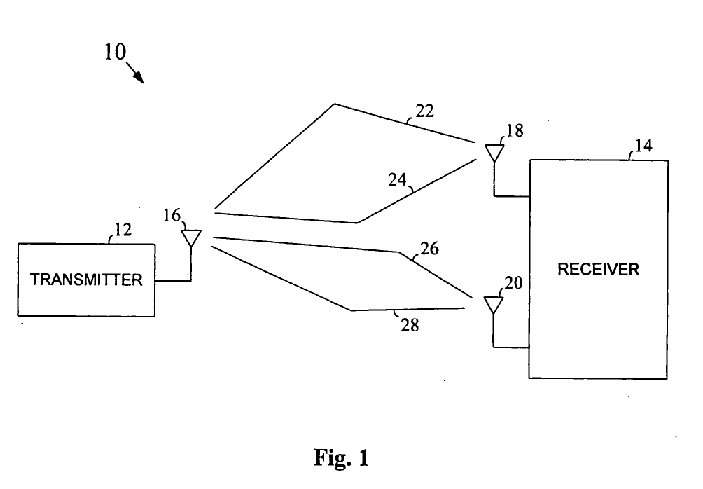

FIG. 1 is a diagram illustrating a wireless communication arrangement 10 that may implement features of the present invention. As shown, a transmitting device 12 is communicating with a receiving device 14 through a wireless channel. In the illustrated arrangement, the transmitting device 12 has a single antenna 16 and the receiving device 14 has two antennas 18, 20. When a signal is transmitted from the transmitting device 12 to the receiving device 14, it will be received by each of the two antennas 18, 20 of the receiving device 14. In addition, the signal may take multiple different paths to each of the antennas 18, 20. For example, a signal might take a first path 22 and a second path 24 from antenna 16 to antenna 18. Similarly, the signal might take a first path 26 and a second path 28 from antenna 16 to antenna 20. These different paths may involve, for example, signal reflections from objects or other conditions in a surrounding environment. This phenomenon is known as multipath propagation.

When the signals arrive at the receiving device 14, the receiving device 14 must process the signals to recover the data that was originally transmitted by the transmitting device 12. Effects in the channel (e.g., inter-symbol interference (ISI), etc.) can distort the signals as they propagate to the receiving device 14, making data recovery more difficult. Various techniques may be used within the receiving device 14 to reduce the negative effects of the channel on the signals. One such technique involves the use of equalization. An equalizer is a filter that may be used in a receive chain to remove many of the distortion effects from a signal that has propagated through a channel. Filter coefficients (or tap weights) may be applied to the equalizer to configure it to behave in a desired manner. Channel knowledge is generally required to generate the filter taps to be used by the equalizer. In a multi-antenna system, a separate equalizer may be used for each of the available antennas.

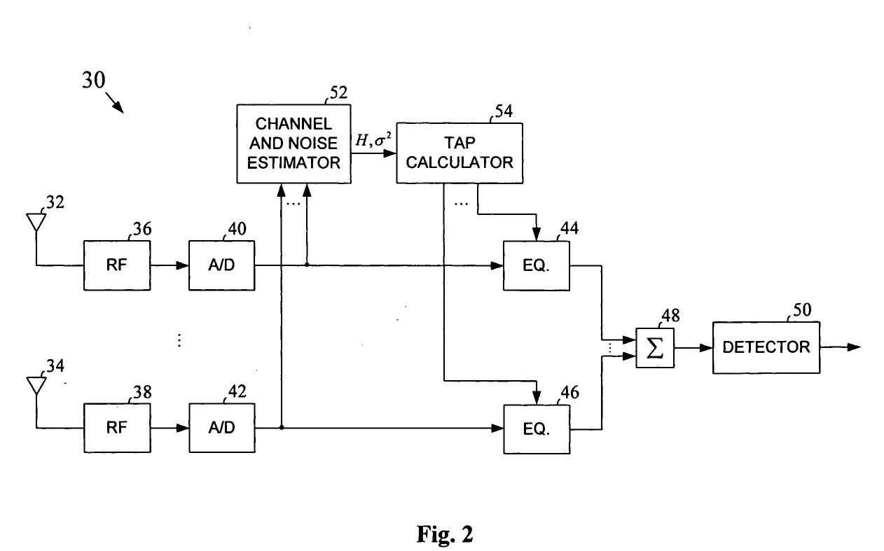

FIG. 2 is a block diagram illustrating a portion of an example wireless receiver 30 in accordance with an embodiment of the present invention. In the illustrated embodiment, the wireless receiver 30 uses two receive antennas 32, 34 to receive signals from a wireless channel. More antennas may be added. For each of the antennas 32, 34, the wireless receiver 30 includes a corresponding radio frequency (RF) section 36, 38; an analog-to-digital (A/D) converter 40, 42; and an equalizer 44, 46. Each RF section 36, 38 receives an RF receive signal from a corresponding antenna 32, 34 and processes the signal to generate a baseband representation of the signal at an output thereof. The A/D converter 40, 42 then digitizes the baseband signal. The digital samples may then be delivered to a corresponding equalizer 44, 46 for equalization to remove channel distortion effects (e.g., ISI).

The equalizers 44, 46 may be, for example, linear finite impulse response (FIR) filters (transversal filters). A FIR filter generally includes a delay line with taps at T second intervals. T may be, for example, the symbol duration. For each tap, a tap weight (or equalizer coefficient) is assigned to achieve a desired filter transfer function. The weighted sample values are summed in the filter to form output samples. The equalizer basically performs a convolution operation of the input samples {x(k)} with the tap weights to form the output samples {z(k)}.

The outputs of the equalizers 44, 46 are delivered to a summer 48 which sums the filtered signals to obtain an estimate of the data originally transmitted by the corresponding transmitting device, [symbol] x [symbol] . A detector 50 may also be provided to perform a final decision operation for the data. The output of the detector 50 may then be delivered to other circuitry for further processing. Any type of antennas 32, 34 may be used with the receiver 30 including, for example, dipoles, patches, helical antennas, and/or others.

In many wireless systems, it is common for the characteristics of the wireless channel to change with time. This is especially true in mobile systems where one or more terminals are allowed to move about during communication operations. For this reason, the filter characteristics of the equalizers 44, 46 will also have to change with time in a manner that reflects the changing channel. The channel and noise estimator 52 is operative for generating channel and noise information (e.g., a channel matrix, H; noise variance, σ²; etc.) for each of the receive antennas 32, 34. To generate the channel information, it is typically necessary to send training data (e.g., pseudo random sequences, known data patterns, etc.), that is known to the channel and noise estimator 52, to the receiver 30 through the channel of interest. The training data may also be used to develop the noise information. When the receiver 30 receives signals that include the training data, it may direct the training data to the channel and noise estimator 52 for use in generating the channel and noise information.

The tap calculator 54 uses channel and noise information generated by the channel and noise estimator 52 to generate the configuration information (e.g., tap weights, etc.) to be delivered to the equalizers 44, 46 to configure them to accurately filter the received signals. The tap calculator 54 may generate tap weights that are designed to achieve a predetermined goal within the equalizers 44,46 when processing received signals. One such goal may be the minimization of the mean square error between desired data symbols and estimated data symbols in the equalizer. This technique may be referred to as minimum mean square error (MMSE) equalization. The implementation of MMSE equalization can be computationally complex, especially for multi-antenna systems. For example, in past systems, the determination of tap weights for MMSE equalization in a multiple antenna receiver system typically required the inversion of an kN×kN matrix, where k is the number of antennas and N is the number of samples on the receiving side, for each receiving antenna (i.e., the samples denoted Y in the equation below). N is also the number of taps that will be used in the derived filter. As is well known, matrix inversion operations can consume large amounts of system resources and the larger the size of the matrix to be inverted, the more resources that will be consumed by the inversion. In one aspect of the present invention, techniques are provided for reducing the computational complexity associated with generating MMSE equalization coefficients for equalizers in a multi-antenna receiver.

In a receiver having K antennas, a vector Yi of samples received by an antenna i may be expressed as:
Yᵢ=HᵢX+ηᵢ
where Hᵢ is the channel matrix associated with antenna i, X represents the samples transmitted to the receiver from a remote transmitting device, and ηᵢ represents the noise associated with antenna i (which is assumed to be white, with variance σ²). The noise in different antennas is assumed to be independent. For a multiple antenna system, the MMSE equalizer W is a set of K filters Wᵢ. The estimated X (i.e., <x>) in the system may be expressed as:

$$〈 x 〉 = {\sum }_{i} {W}_{i}^{+} {Y}_{i}$$

where Wᵢ⁺ represents the conjugate transpose of filter Wᵢ. The filters Wᵢ are given by:

$$W = [ \begin{matrix}{W}_{1} \\ {W}_{2} \\ ⋮ \\ {W}_{k}\end{matrix} ] = {C}^{- 1} [ \begin{matrix}{H}_{1} \\ {H}_{2} \\ ⋮ \\ {H}_{k}\end{matrix} ] \qquad ( Equation 1 )$$

where C is the received samples autocorrelation matrix, which is a K×K block matrix, with block (i, j) given by:
Cᵢⱼ=E(YᵢYⱼ⁺)=Hᵢ=Hⱼ⁺+σᵢ²δᵢⱼI.
For i=j, E(YᵢYⱼ⁺) is the autocorrelation matrix of the samples received by antenna i.
For i≠j, E(Y₁Yⱼ⁺) is the cross correlation matrix for samples received by antennas i and j.

As shown in Equation 1 above, the generation of the filters Wᵢ for a multi-antenna receiver requires the inversion of the received samples autocorrelation matrix C. It is shown below that the inversion operation can be simplified significantly by noting that the blocks of the matrix C are all Toeplitz. For ease of description and to facilitate understanding, the discussion that follows is for a two antenna receiver. When K=2, the received samples autocorrelation matrix C is:

$$C = [ \begin{matrix}{H}_{1} {H}_{1}^{+} + {σ}_{1}^{2} I & {H}_{1} {H}_{2}^{+} \\ {H}_{2} {H}_{1}^{+} & {H}_{2} {H}_{2}^{+} + {σ}_{2}^{2} I\end{matrix} ] .$$

Each of the blocks within the matrix C is Toeplitz. That is, except for boundary elements, the blocks behave like linear filters and therefore commute (AB=BA). Since the blocks commute, they may be treated as individual numbers in the form:

$$M = [ \begin{matrix}a & b \\ c & d\end{matrix} ] .$$

The inverted version of M is thus:

$${M}^{- 1} = {det}^{- 1} [ \begin{matrix}d & - b \\ - c & a\end{matrix} ] .$$

where det is the determinant of matrix M and is equal to ad−bc. Applying this principle to the matrix C results in the following:

$${C}^{- 1} = {DET}^{- 1} [ \begin{matrix}{H}_{2} {H}_{2}^{+} + {σ}_{2}^{2} I & - {H}_{1} {H}_{2}^{+} \\ - {H}_{2} {H}_{1}^{+} & {H}_{1} {H}_{1}^{+} + {σ}_{1}^{2} I\end{matrix} ]$$

where:
DET=(H₁H₁⁺+σ₁²I)*(H₂H₂⁺+σ₂²I)−H₁H₂⁺H₂H₁⁺
which simplifies to:
DET=H₁H₁⁺σ₂²I+H₂H₂⁺σ₁²I+σ₁²σ₂²I.
From the above expressions, W can be calculated as follows:

$$[ \begin{matrix}{W}_{1} \\ {W}_{2}\end{matrix} ] = {DET}^{- 1} [ \begin{matrix}{H}_{2} {H}_{2}^{+} + {σ}_{2}^{2} I & - {H}_{1} {H}_{2}^{+} \\ - {H}_{2} {H}_{1}^{+} & {H}_{1} {H}_{1}^{+} + {σ}_{1}^{2} I\end{matrix} ] [ \begin{matrix}{H}_{1} \\ {H}_{2}\end{matrix} ] \\ [ \begin{matrix}{W}_{1} \\ {W}_{2}\end{matrix} ] = {DET}^{- 1} \begin{matrix}{σ}_{2}^{2} {H}_{1} \\ {σ}_{1}^{2} {H}_{2}\end{matrix} \\ [ \begin{matrix}{W}_{1} \\ {W}_{2}\end{matrix} ] = {( {H}_{1} {H}_{1}^{+} / {σ}_{1}^{2} + {H}_{2} {H}_{2}^{+} / {σ}_{2}^{2} + I )}^{- 1} [ \begin{matrix}{H}_{1} / {σ}_{1}^{2} \\ {H}_{2} / {σ}_{2}^{2}\end{matrix} ] .$$

The result of the above-described technique is that the size of the matrix that needs to be inverted is reduced by a factor of 2. That is, instead of inverting the entire matrix C, the smaller determinant matrix DET can be inverted. This reduction in the size of the matrix to be inverted can reduce the computation complexity of generating the equalizer configuration information considerably. In addition, it may also provide numerical robustness. That is, the decrease in the dimension of the matrix to be inverted makes the inversion more stable numerically which may result in improved performance over previous techniques.

In the discussion above, it is assumed that there is a single transmitting base. However, in a typical network scenario, there will be multiple base stations transmitting in the vicinity of a receiving device, only one of which is a base station of interest. In the description that follows, expressions are provided that allow equalizer configuration information to be efficiently generated for a multiple antenna system for the case of multiple transmitting bases. As in the case of a single transmitting antenna, the matrix C is a block matrix with k×k blocks, where each block has a size N×N (where N is the size of the window of received samples, in each receiving antenna, on which the equalizer is calculated and is also the equalizer size). In this situation, the received signal may be expressed as:

$${Y}_{i} = {\sum }_{b} {H}_{i}^{b} {X}_{b} + {η}_{i}$$

where i is the receiver antenna index and b is the transmitting base index. If the base station of interest is station 0 (i.e., b=0) and the receiving device includes two antennas (i=1, 2), then the filters Wᵢ are given by the expression:

$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$

The block matrix C is therefore a 2x2 matrix, with block (ij) given by:

$${C}_{ij} = E ( {Y}_{i} {Y}_{j}^{+} ) = {\sum }_{b} {H}_{i}^{b} {H}_{j}^{b +} + {σ}_{i}^{2} {δ}_{ij} I .$$

The inverted block matrix C’ may be expressed as:

$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ]$$

where

$$DET = ( {\sum }_{b} {H}_{1}^{b} {H}_{1}^{b +} + {σ}_{1}^{2} I ) ( {\sum }_{b} {H}_{2}^{b} {H}_{2}^{b +} + {σ}_{2}^{2} I ) - ( {\sum }_{b} {H}_{1}^{b} {H}_{2}^{b +} ) ( {\sum }_{b} {H}_{2}^{b} {H}_{1}^{b +} ) .$$

Because the H matrices commute, the above expression simplifies to:

$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I .$$

In at least one embodiment of the invention, the above equations for DET and C⁻¹ may be utilized within, for example, the tap calculator 54 of FIG. 2 to calculate tap weights for the equalizers 44, 46 in a computationally efficient manner.

In the various expressions set out above, the noise variance σᵢ² associated with antenna i appears frequently. This noise variance may be determined in a variety of different ways. In one approach, for example, the H matrices of all base stations are first estimated for each antenna, using training information. The noise variance may then be estimated using the equations:

$${C}_{ij} = E ( {Y}_{i} {Y}_{j}^{+} ) = {\sum }_{b} {H}_{i}^{b} {H}_{j}^{b +} + {σ}_{i}^{2} {δ}_{ij} I .$$

The left hand side of these equations is measured directly by the time average Cᵢⱼ=E(YᵢYⱼ⁺). The H matrices are known and the noise variances can therefore be estimated. A similar technique may be used for devices having more than two antennas. In another possible approach, the H matrix is only estimated for the base station of interest, using the training data. The matrix C that needs to be inverted is then calculated (as just mentioned) by the time average Cᵢⱼ=E(YᵢYⱼ⁺). Using this approach, there is no need for a separate antenna noise estimation. Other techniques may also be used.

In the description that follows, an exact formula for reducing the computational complexity of the MMSE filter generation process for a multi-antenna system is derived for the case of single transmitting antenna. It can shown that this exact formula is substantially the same as the result derived previously for the single transmitting antenna case. As described previously, the C matrix is a K×K block matrix, with block (i, j) given by:

$${C}_{ij} = E ( {Y}_{i} {Y}_{j}^{+} ) = {H}_{i} {H}_{j}^{+} + {σ}_{i}^{2} {δ}_{ij} I .$$

The block matrix C may be expressed as follows:
C=HH⁺+A
where H is a vector of blocks:

$$H = [ \begin{matrix}{H}_{1} \\ {H}_{2} \\ ⋮ \\ {H}_{k}\end{matrix} ]$$

and A is a noise block matrix which is diagonal in blocks and diagonal inside the blocks. Equation 1 above can now be rewritten as:
(HH⁺+A)W=H.

To simplify the calculation of the MMSE equalizer W, the following relationship may be defined:

$${H}^{+} W = {\sum }_{i = 1}^{k} {H}_{i}^{+} {W}_{i} = m$$

where m is of the size of a single block. The equation for W then becomes:
Hm+AW=H
where m multiplies each element of H. The solution of the above equation is:
W=A⁻H(1−m) (Equation 2)
where the “1” represents a unity matrix of one block size. Multiplying both sides of Equation 2 by H⁺ results in the following expression for m:
m=H⁺A⁻¹H(1−m)
where

$${H}^{+} {A}^{- 1} H = {\sum }_{i} {H}_{i}^{+} {A}_{i}^{- 1} {H}_{i} .$$

Solving for (1−m) results in:

$$1 - m = \frac{1}{1 + {H}^{+} {A}^{- 1} H} . \qquad ( Equation 3 )$$

Substituting Equation 3 into Equation 2 results in the following solution for W:
W=A⁻¹H(1+H⁺A⁻¹H)⁻¹ (Equation 4)
which is an exact expression for W. Significantly, the above expression only requires the inversion of a matrix having the size of a single block, regardless of the number of antennas being used. In at least one embodiment of the invention, Equation 4 may be utilized within, for example, the tap calculator 54 of FIG. 2 to calculate tap values for the equalizers 44, 46 in a computationally efficient manner when only a single transmitting base station is operative. It can be shown that Equation 4 provides substantially the same result as the equations for W derived earlier for the case of the single transmitting base when assuming that the H matrices commute.

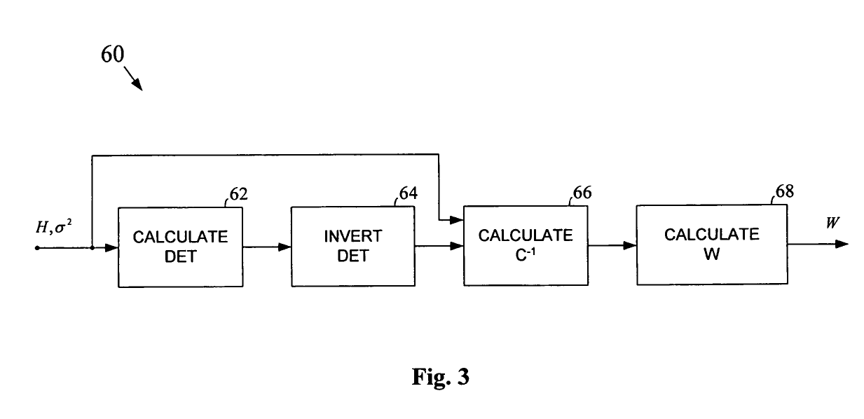

FIG. 3 is a diagram illustrating an example processing sequence 60 that may be performed to generate MMSE filter configuration information in an efficient manner in a multiple antenna wireless receiver in accordance with an embodiment of the present invention. The processing sequence 60 may be performed within, for example, the tap calculator 54 of FIG. 2 or in another processor or system. For simplicity, the processing sequence 60 will be described in the context of a receiving device having two receive antennas. The H matrices and the noise variance σ² information for the 2 antennas are first obtained. This information may be determined using training data received from a corresponding transmitting device (e.g., base station of interest). The information is then used to calculate the determinant (DET) matrix of the received samples autocorrelation matrix C (block 62). As described previously, in a 2 antenna system, the following equation may be used:

$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I .$$

In a system having more than 2 antennas, a similar expression may be used. The DET matrix may then be inverted (block 64). The inverted DET matrix may then be used to calculate the inverted block matrix C⁻¹ (block 66). This may be performed using the equation:

$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ] .$$

The inverted block matrix C⁻¹ may then be used to generate the MMSE filters W as follows:

$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$

for a base station of interest having b=0 (block 68).

It should be appreciated that the various blocks in FIG. 3 are functional in nature and may be implemented in a variety of ways. For example, the blocks may each represent a separate device, system, or component within a communication device. Alternatively, some or all of the blocks may be implemented within a single structure (e.g., a single digital processing device). In one approach, for example, each block is representative of a different software object, module, routine, or set of instructions to be executed within a digital processing device. The processing device may include, for example, a general purpose microprocessor, a digital signal processor (DSP), a reduced instruction set computer (RISC), a complex instruction set computer (CISC), a field programmable gate array (FPGA), an application specific integrated circuit (ASIC), a microcontroller, and/or others, including combinations of the above. Hardware, software, firmware, and hybrid implementations may be used. As used herein, the term “logic” may include, by way of example, software or hardware and/or combinations of software and hardware.

The techniques and structures of the present invention may be implemented in any of a variety of different forms. For example, features of the invention may be embodied within laptop, palmtop, desktop, and tablet computers having wireless capability; personal digital assistants (PDAs) having wireless capability; cellular telephones and other handheld wireless communicators; pagers; satellite communicators; cameras having wireless capability; audio/video devices having wireless capability; network interface cards (NICs) and other network interface structures; base stations; wireless access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
calculating a determinant matrix DET of a received samples autocorrelation block matrix C associated with a minimum mean square error (MMSE) equalizer W in a K antenna receiver, where K is an integer greater than 1;
inverting said determinant matrix DET to generate an inverted determinant matrix DET⁻¹;
using said inverted determinant matrix DET⁻¹ to calculate an inverted version of said received samples autocorrelation block matrix C⁻¹;
generating tap weights for said MMSE equalizer W using said inverted received samples autocorrelation block matrix C⁻¹; and
applying said tap weights to filters within said K antenna receiver for use in filtering signals received by corresponding antennas.

2. The method of claim 1, wherein:
said K antenna receiver includes 2 antennas; and
calculating a determinant matrix includes calculating the following:
$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I$$
where H₁ is a channel matrix associated with a first receive antenna, σ₁² is a noise variance associated with said first receive antenna, H₂ is a channel matrix associated with a second receive antenna, σ₂² is a noise variance associated with said second receive antenna, b is a base station index, I is the identity matrix, and ⁺ is the conjugate transpose operator.

3. The method of claim 2, wherein:
using said inverted determinant matrix to calculate an inverted version of said received samples autocorrelation block matrix C⁻¹ includes evaluating the following equation:
$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ] .$$

4. The method of claim 3, wherein:
generating tap weights includes evaluating the following expression:
$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$
where H₁⁰ is the channel matrix associated with a desired base station for said first receive antenna and H₂⁰ is the channel matrix associated with said desired base station for said second receive antenna.

5. An apparatus comprising:
a first equalizer to process signals received by a first receive antenna;
a second equalizer to process signals received by a second receive antenna; and
a tap calculator to generate tap weights for said first and second equalizers, said tap calculator including:
logic to calculate a determinant matrix DET of a received samples autocorrelation block matrix C associated with said first and second equalizers;
logic to invert said determinant matrix DET to generate an inverted determinant matrix DET⁻¹;
logic to calculate an inverted version of said received samples autocorrelation block matrix C using said inverted determinant matrix DET⁻¹; and
logic to generate tap weights for said first and second equalizers using said inverted received samples autocorrelation block matrix C⁻¹.

6. The apparatus of claim 5, wherein:
said apparatus includes only two receive antennas; and
said logic to calculate a determinant matrix includes logic to evaluate the following equation:
$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I$$
where H₁ is a channel matrix associated with said first receive antenna, σ₁² is a noise variance associated with said first receive antenna, H₂ is a channel matrix associated with said second receive antenna, σ₂² is a noise power associated with said second receive antenna, b is a base station index, I is the identity matrix, and ⁺ is the conjugate transpose operator.

7. The apparatus of claim 6, wherein:
said logic to calculate an inverted version of said received samples autocorrelation block matrix C includes logic to evaluate the following equation:
$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ] .$$

8. The apparatus of claim 7, wherein:
said logic to generate tap weights includes logic to evaluate the following equation:
$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$
where H₁⁰ is the channel matrix associated with a desired base station for said first receive antenna and H₂⁰ is the channel matrix associated with said desired base station for said second receive antenna.

9. The apparatus of claim 5, further comprising:
at least one additional equalizer to process signals received by at least one additional receive antenna, wherein said tap calculator also generates tap weights for said at least one additional equalizer.

10. A system comprising:
at least two dipole receive antennas;
a first equalizer to process signals received by a first dipole receive antenna;
a second equalizer to process signals received by a second dipole receive antenna; and
a tap calculator to generate tap weights for said first and second equalizers, said tap calculator including:
logic to calculate a determinant matrix DET of a received samples autocorrelation block matrix C associated with said first and second equalizers;
logic to invert said determinant matrix DET to generate an inverted determinant matrix DET⁻¹;
logic to calculate an inverted version of said received samples autocorrelation block matrix C using said inverted determinant matrix DET⁻¹;
logic to generate tap weights for said first and second equalizers using said inverted received samples autocorrelation block matrix C⁻¹.

11. The system of claim 10, wherein:
said system includes only two receive antennas; and
said logic to calculate a determinant matrix includes logic to evaluate the following equation:
$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I$$
where H₁ is a channel matrix associated with said first dipole receive antenna, σ₁² is a noise power associated with said first dipole receive antenna, H₂ is a channel matrix associated with a second dipole receive antenna, σ₂² is a noise power associated with said second dipole receive antenna, b is a base station index, I is the identity matrix, and ⁺ is the conjugate transpose operator.

12. The system of claim 11, wherein:
said logic to calculate an inverted version of said received samples autocorrelation block matrix C includes logic to evaluate the following equation:
$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ] .$$

13. The system of claim 12, wherein:
said logic to generate tap weights includes logic to evaluate the following expression:
$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$
where H₁⁰ is the channel matrix associated with a desired base station for said first dipole receive antenna and H₂⁰ is the channel matrix associated with said desired base station for said second dipole receive antenna.

14. The system of claim 10, further comprising:
at least one additional equalizer to process signals received by at least one additional receive antenna, wherein said tap calculator also generates tap weights for said at least one additional equalizer.

15. An article comprising a storage medium having instructions stored thereon that, when executed by a computing platform, operate to:
calculate a determinant matrix DET of a received samples autocorrelation block matrix C associated with a minimum mean square error (MMSE) equalizer W in a K antenna receiver, where K is an integer greater than 1;
invert said determinant matrix DET to generate an inverted determinant matrix DET⁻¹;
calculate an inverted version of said received samples autocorrelation block matrix C using said inverted determinant matrix DET⁻¹; and
generate tap weights for said MMSE equalizer W using said inverted received samples autocorrelation block matrix C⁻¹.

16. The article of claim 15, wherein:
said K antenna receiver includes 2 antennas; and
operation to calculate a determinant matrix includes operation to evaluate the following equation:
$$DET = {σ}_{2}^{2} {\sum }_{b} {H}_{1}^{b} {H}_{1}^{b +} + {σ}_{1}^{2} {\sum }_{b} {H}_{2}^{b} {H}_{2}^{b +} + {σ}_{1}^{2} {σ}_{2}^{2} I$$
where H₁ is a channel matrix associated with a first receive antenna, σ₁² is a noise power associated with said first receive antenna, H₂ is a channel matrix associated with a second receive antenna, σ₂² is a noise power associated with said second receive antenna, b is a base station index, I is the identity matrix, and ⁺ is the conjugate transpose operator.

17. The article of claim 16, wherein:
operation to calculate an inverted version of said received samples autocorrelation block matrix C includes operation to evaluate the following equation:
$${C}^{- 1} = [ \begin{matrix}{DET}^{- 1} & 0 \\ 0 & {DET}^{- 1}\end{matrix} ] [ \begin{matrix}{\sum }_{b} {H}_{2}^{b} {H}_{2}^{b +} + {σ}_{2}^{2} I & - {\sum }_{b} {H}_{1}^{b} {H}_{2}^{b +} \\ - {\sum }_{b} {H}_{2}^{b} {H}_{1}^{b +} & {\sum }_{b} {H}_{1}^{b} {H}_{1}^{b +} + {σ}_{1}^{2} I\end{matrix} ] .$$

18. The article of claim 17, wherein:
operation to generate tap weights includes operation to evaluate the following equation:
$$W = [ \begin{matrix}{W}_{1} \\ {W}_{2}\end{matrix} ] = {C}^{- 1} [ \begin{matrix}{H}_{1}^{0} \\ {H}_{2}^{0}\end{matrix} ]$$
where H₁⁰ is the channel matrix associated with a desired base station for said first receive antenna and H₂⁰ is the channel matrix associated with said desired base station for said second receive antenna.

19. The article of claim 15, wherein:
operation to generate tap weights includes operation to generate tap weights for at least three filters associated with at least three corresponding receive antennas.
